(19) United States
(12) Patent Application Publication
(10) Pub. No.: US 2013/0254291 A1
(43) Pub. Date: Sep. 26, 2013

(54) METHOD FOR SHARING HOME SCREEN

(71) Applicant: SAMSUNG ELECTRONICS CO., LTD., Gyeonggi-do (KR)

(72) Inventors: Jin Park, Gyeonggi-do (KR); Min-Ji Kim, Seoul (KR); Yong-Soo Jeong, Gyeonggi-do (KR)

(73) Assignee: Samsung Electronics Co., Ltd., Gyeonggi-do (KR)

(21) Appl. No.: 13/847,963

(22) Filed: Mar. 20, 2013

(30) Foreign Application Priority Data
Mar. 20, 2012 (KR) 10-2012-0028410

(51) Int. Cl. H04L 29/06

(52) U.S. Cl. CPC H04L 65/403
USPC 709/204

(57) ABSTRACT

A method for sharing a home screen is provided. The method includes determining whether a sharing condition for a shared home screen is satisfied, by an N-screen device supporting an N-screen service; if the sharing condition is satisfied, transmitting, by the N-screen device, a shared home screen set to be shared in the N-screen device, to another N-screen device supporting the N-screen service; and receiving and displaying the transmitted shared home screen, by the other N-screen device.

### CROSS-REFERENCE TO RELATED APPLICATION(S) AND CLAIM OF PRIORITY

The present application is related to and claims the benefit under 35 U.S.C. §119(a) of a Korean Patent Application filed in the Korean Intellectual Property Office on Mar. 20, 2012 and assigned Serial No. 10-2012-0028410, the entire disclosure of which is incorporated herein by reference.

### TECHNICAL FIELD OF THE INVENTION

The present disclosure relates generally to a method for sharing screens, and more particularly, to a method for sharing home screens during an N-screen service.

### BACKGROUND OF THE INVENTION

Portable terminals have evolved into smart phones that provide users with various useful services with the help of applications providing a variety of functions, leading to common use of portable terminals.

Recently, users may enjoy multimedia content on several other devices, such as tablet Personal Computers (PCs) and laptop PCs, as well as portable terminals (e.g., smart phones), carrying the devices with them. Users may also enjoy multimedia content on home appliances such as televisions (TVs) at home.

Due to the developments in multimedia environment, which allow users to enjoy multimedia content on various electronic devices, new services capable of taking full advantage of these electronic devices have also been proposed. A typical example of these services is an N-screen service.

The N-screen service is a multi-screen service that allows users to seamlessly enjoy the same content on different electronic devices such as TVs, desktop PCs, and portable terminals. In this service, users may enjoy the content on multiple devices through interaction between screens of multiple electronic devices, unlike in the conventional single-screen service where users enjoy the content only on a single device. For example, in South Korea, LGT™ provides U+Box®, SKT™ provides Hoppin®, and KT™ provides Ucloud® as their own N-screen service. Internationally, Apple™ provides iCloud®, AT&T™ provides U-verse® , and Comcast™ provides XFINITY® as their own the N-screen service.

However, the conventional N-screen service does not define the UserInterface (UI) or UserExperience (UX), on which the devices connected by the N-screen functionality may support the N-screen service.

The conventional N-screen service is inconvenient when users enjoy the N-screen service on a TV and a potable terminal at home, or when passengers enjoy the N-screen service on a tablet PC and a portable terminal in a car, since it does not define the UI or UX by which the users may enjoy the N-screen service in an interactive way.

Therefore, there is a need to improve the usability of the N-screen service by providing a UI or a UX, which is more convenient and easier to access the N-screen service.

### SUMMARY OF THE INVENTION

To address the above-discussed deficiencies of the prior art, it is a primary object to provide a method for allowing devices connected by an N-screen service to share home screens and take good advantage of the shared home screens, making it possible for a user to enjoy the N-screen service more conveniently and usefully.

In accordance with an aspect of the present disclosure, a method for sharing a home screen is provided. The method includes determining whether a sharing condition for a shared home screen is satisfied, by an N-screen device supporting an N-screen service; if the sharing condition is satisfied, transmitting, by the N-screen device, a shared home screen set to be shared in the N-screen device, to another N-screen device supporting the N-screen service; and receiving and displaying the transmitted shared home screen, by the other N-screen device.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a block diagram of an N-screen device according to an embodiment of the present disclosure;

FIG. 2 illustrates a process of sharing home screens according to an embodiment of the present disclosure;

FIGS. 3A and 3B illustrate processes of sharing home screens according to an embodiment of the present disclosure;

FIG. 4 illustrates processes of sharing home screens according to another embodiment of the present disclosure;

FIG. 5 illustrates processes of sharing home screens according to further another embodiment of the present disclosure; and

FIG. 6 illustrates processes of sharing home screens according to still another embodiment of the present disclosure.

### DETAILED DESCRIPTION OF THE INVENTION

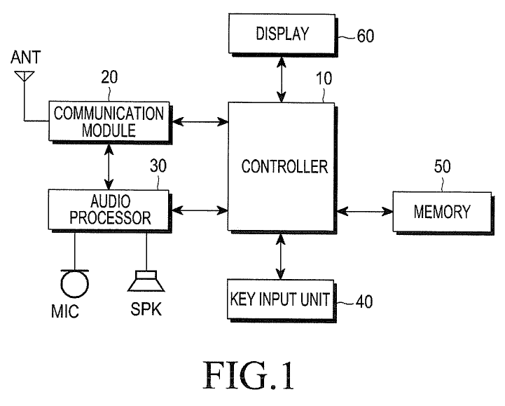

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device. Embodiments of the present disclosure are described in detail with reference to the accompanying drawings. The same or similar components may be designated by the same or similar reference numerals although they are illustrated in different drawings. Further, various specific definitions found in the following description, such as specific values of packet identifications, contents of displayed information, etc., are provided only to help general understanding of the present disclosure, and it is apparent to those skilled in the art that the present disclosure can be implemented without such definitions. Detailed descriptions of constructions or processes known in the art maybe omitted to avoid obscuring the subject matter of the present disclosure.

FIG. 1 illustrates a block diagram of an N-screen device according to an embodiment of the present disclosure. In an embodiment of the present disclosure, the N-screen device may include all devices capable of supporting an N-screen service, including televisions (TVs) and portable electronic devices such as tablet personal computers (PCs), desktop PCs, laptop PCs, and smart phones. The N-screen device will be described in detail below with reference to FIG. 1.

A communication module 20, which is responsible for wireless communication of the N-screen device, may include at least one of a Radio Frequency (RF) transmission/reception module, a short-range communication module (e.g., a Near Field Communications (NFC) module and a Wireless Fidelity (Wi-Fi) module), and a wired communication module.

An audio processor 30 may include a codec such as a data codec and an audio codec. The data codec processes packet data and the like, and the audio codec processes audio signals such as voice signals and multimedia files. The audio processor 30 may be incorporated in a controller 10.

A key input unit 40 may include keys required to input numeral and character information, and function keys for setting various functions of the N-screen device. The key input unit 40 may provide hardware keys, virtual keys (constituting a virtual keypad) provided or displayed on a touch screen of a display 60, or a combination of the hardware and virtual keys. If the N-screen device is a shared N-screen device (e.g., a TV), the key input unit 40 may be a remote controller.

A memory 50 may include a program memory and a data memory. The program memory stores a program for controlling the general operation of the N-screen device. The memory 50 may further include a disk, such as a Hard Disk Drive (HDD) and a Solid State Disk (SDD), and an external memory, such as a Compact Flash (CF) card, a Secure Digital (SD) card, a micro-SD card, a mini-SD card, an eXtreme Digital (xD) card, and a memory stick.

The display 60, which may be made of a Liquid Crystal Display (LCD) or an Organic Light Emitting Diode (OLED) (e.g., a Passive Matrix OLED (PMOLED) or an Active Matrix (AMOLED)), outputs various display information generated by the N-screen device. The display 60 may include a capacitive or resistive touch screen, and may support or replace a function of the key input unit 40 for controlling the N-screen device.

The display 60 may be implemented to have different display screen size and resolution according to a type of the N-screen device. For example, if the N-screen device is a shared N-screen device, the N-screen device may have a large display screen size (e.g., a screen size of 46 inches) and a resolution of Full High Definition (FHD). If the N-screen device is one of the first and second N-screen devices, the N-screen device may have a display screen size of 4.65 inches and a resolution of High Definition (HD). The first and second N-screen devices each may be, for example, a smart phone or a tablet PC, and may be less than the shared N-screen device in both the display screen size and the resolution.

The controller 10 controls the overall operation of the N-screen device (e.g., the shared N-screen device and the first and second N-screen devices), and may switch and control operations of the N-screen device according to user inputs received through the key input unit 40 or the display 60.

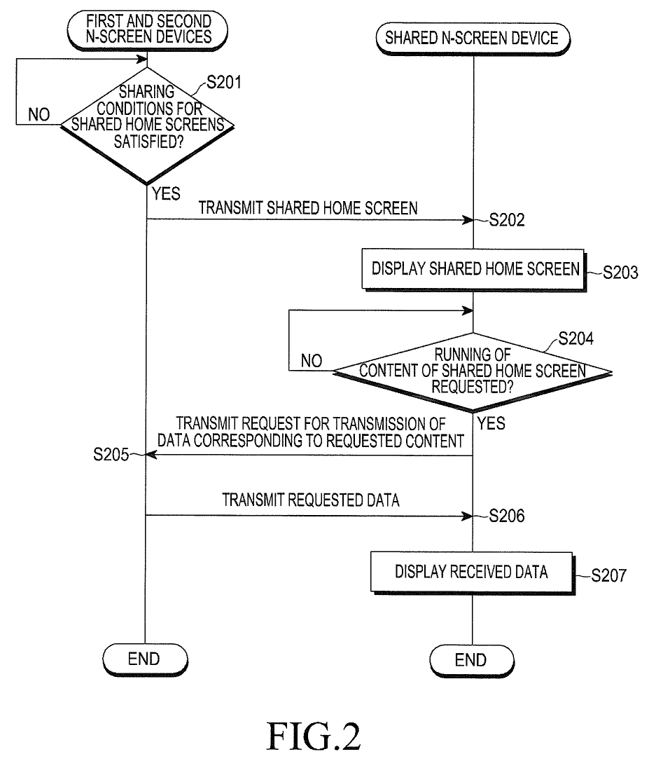

Although it is assumed in FIG. 2 that the shared N-screen device and the first and second N-screen devices control their operations, it will be understood by those of ordinary skill in the art that operations of the shared N-screen device and the first and second N-screen devices may be controlled by their controller 10.

Although additional devices, which may be included in the N-screen device, such as a Bluetooth module, a camera module, an acceleration sensor, a proximity sensor, a geomagnetic sensor, and a Digital Media Broadcasting (DMB) receiver, are not shown in FIG. 1, it is apparent to those skilled in the art that these additional devices may also be included in the N-screen device to provide their own functions.

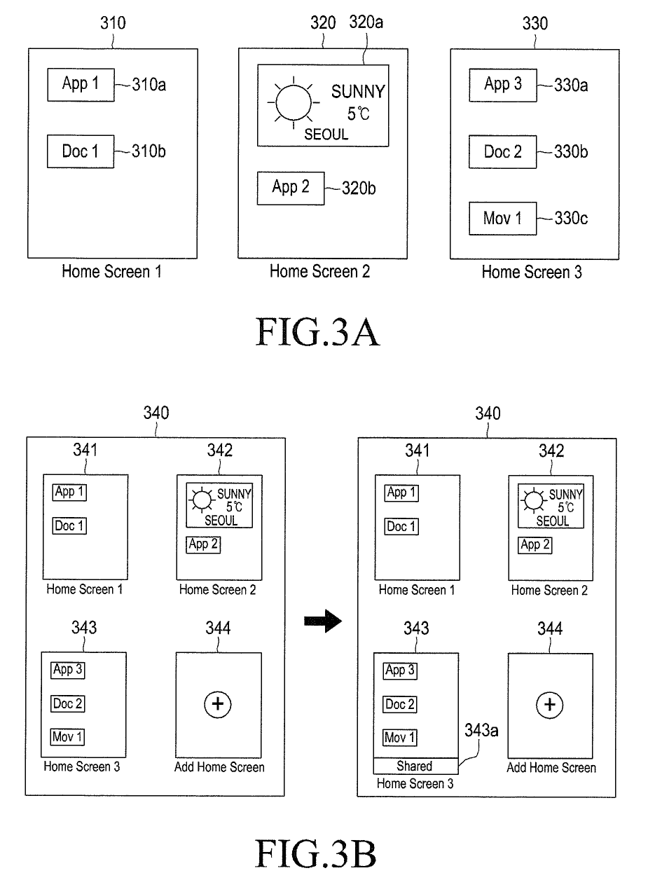

FIG. 2 illustrates a process of sharing home screens according to an embodiment of the present disclosure. FIGS. 3A to 6 illustrate different examples of processes of sharing home screens according to an embodiment of the present disclosure. An embodiment of the present disclosure will be described in detail below with reference to FIGS. 2 to 6.

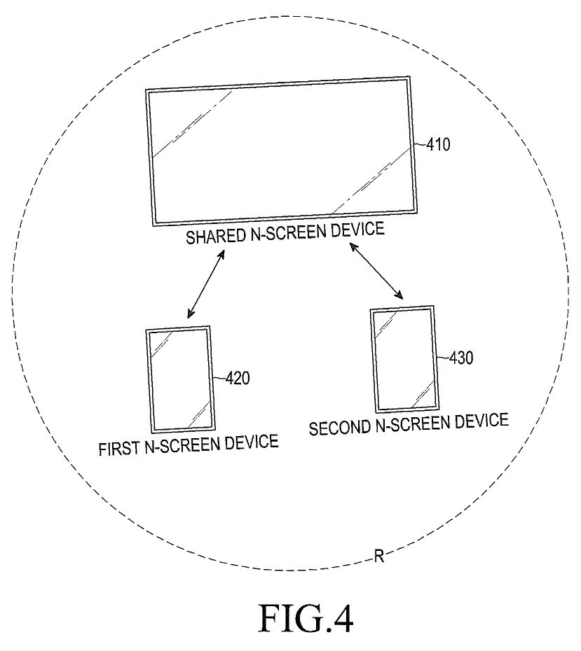

Referring to FIG. 2, an arbitrary N-screen device (e.g., one of the first and second N-screen devices 420 and 430 shown in FIG. 4) determines in step S201 whether sharing conditions for shared home screens are satisfied or not.

An embodiment of the present disclosure is directed to sharing a shared home screen(s) that is set to be shared by N-screen devices supporting an N-screen function. A shared home screen will be described below with reference to FIGS. 3A and 3B. In the example shown in FIG. 3A, a specific N-screen device (e.g., the first N-screen device) includes 3 home screens 310, 320 and 330.

Referring to FIG. 3A, each of the home screens 310, 320 and 330 has icons which are arranged thereon and correspond to the home screens' 310, 320 and 330 associated content. In an embodiment of the present disclosure, content of a home screen may refer to an object(s) which may be arranged or displayed on the home screen, such as icons corresponding to shortcuts to applications, files and videos, and widgets used for providing real-time information on a preset screen, such as weather information, stock information, and device's battery status information. The widgets may be replaced by gadgets, PCs and the like. It is apparent to those skilled in the art that the types of content of the home screen are not limited to those listed above.

In the shown example, an icon 310a corresponding to an application (e.g., App1), and an icon 310b corresponding to a document file (e.g., Doc1) are arranged on the home screen #1 310. On the home screen 310, a user may request running of the application App1 by selecting or touching the icon 310a, or request reading of the file Doc1 by selecting the icon 310b.

A widget 320a, and an icon 320b corresponding to an application are arranged on the home screen #2 320. On the home screen #2 320, the user may check specific information (e.g., weather information) with the widget 320a (e.g., a weather widget), or request running of the application App2 by selecting the icon 320b. The specific information may be periodically updated.

The home screen #3 330 has, for example, an icon 330a corresponding to an application (e.g., App3), an icon 330b corresponding to a file (e.g., Doc2), and an icon 330c corresponding to a video (e.g., Mov1), which are arranged thereon. On the home screen #3 330, a user may request running of the application App3 by selecting the icon 330a, reading or edition of the file Doc2 by selecting the icon 330b, or playback of the video Mov1 by selecting the icon 330c.

Meanwhile, in an embodiment of the present disclosure, a user may set (select) a shared home screen he or she will share with a user of another N-screen device, using a menu related to home screen edition, and the like.

Operation of setting a shared home screen will be described with reference to FIG. 3B. A user may request display of a screen 340 on which he/she may edit home screens by manipulating menus, and then select a home screen #3 343 among home screens of 341-343 as a shared home screen 343a by changing settings.

The user may add a new home screen on a UI 344, and set the added home screen as a shared home screen.

If the first N-screen device transmits a shared home screen to the second N-screen device, a user of the second N-screen device may access (e.g., request running of an application, or request streaming of media files) content (e.g., an icon) included in the shared home screen, using the received shared home screen (i.e., the shared home screen of the first N-screen device) The phrase ‘transmitting a shared home screen’ as used herein may refer to transmitting data constituting a shared home screen. So, when setting the shared home screen, a user of each N-screen device may set access rights (e.g., read/write rights) to individual content of the shared home screen.

For example, if the home screen 330 in FIG. 3A is set as a shared home screen, the shared home screen may be set such that read rights are given for content 330a, and read/write rights are given for content 330b and 330c. Therefore, when transmitting the shared home screen, a transmitting N-screen device may transmit setting information for access rights to content of the shared home screen being transmitted, together with the shared home screen. So, upon receiving the setting information for access rights together with the shared home screen, a receiving N-screen device may access content of the shared home screen depending on the access rights.

After a user of an N-screen device sets (selects) a shared home screen he/she intends to share with a user of another N-screen device, the shared home screen may be transmitted to and shared with another N-screen device if sharing conditions for shared home screens are satisfied.

In an embodiment of the present disclosure, it is assumed that the sharing conditions for shared home screens are satisfied if N-screen devices sharing a home screen are located in the same region having a predetermined radius. However, it is apparent to those skilled in the art that the sharing conditions for shared home screens are not limited thereto. For example, it will be understood that the sharing conditions for shared home screens are satisfied, even if users of N-screen devices manually request sharing of shared home screens by manipulating menus.

Referring to FIG. 4, it will be understood that the sharing conditions for shared home screens are satisfied if a shared N-screen device 410 and first and second N-screen devices 420 and 430 are located in the same region with a predetermined radius of R. The shared N-screen device 410 and the first and second N-screen devices 420 and 430 are set to share home screens.

The preset radius R of the region will be assumed as a radius of, for example, home, an office, or a car, within which the shared N-screen device 410, the first and second N-screen devices 420 and 430 may recognize one another and communicate with one another by, for example, 3G communication or Wi-Fi communication.

The N-screen devices 410 to 430, located in the region with the predetermined radius R, may recognize one another by checking whether an acknowledgement (ACK) signal is received in response to a beacon signal related to sharing of home screens, which was transmitted before.

For implementation of the present disclosure, a server (e.g., a cloud server) associated with the N-screen service may acquire location information of N-screen devices in advance and then transmit, to the N-screen devices, data indicating the satisfaction of sharing conditions for shared home screens, if the N-screen devices are located in the region with a predetermined radius.

The operation in which the N-screen devices 410 to 430 recognize one another within the region with a predetermined radius R is well known in the art, so the detailed description may be omitted.

It is shown in FIG. 4 that embodiments of the present disclosure are implemented by the shared. N-screen device 410 and the first and second N-screen devices 420 and 430. However, it will be understood by those of ordinary skill in the art that the number of N-screen devices is not limited.

The N-screen devices 410 to 430, devices supporting the N-screen feature and the home screen sharing feature, may be the same in structure and operation except that the shared N-screen device 410 is greater than the first and second N-screen devices 420 and 430 in screen size and resolution.

For example, the shared N-screen device 410 may be a TV, a tablet PC, a desktop PC and the like, which support the N-screen service, and the first and second N-screen devices 420 and 430 may be a portable terminal (e.g., a smart phone) supporting the N-screen service.

The shared N-screen device 410 with a large display screen, such as a TV, tablet PC, desktop PC (or laptop PC) and the like is suitable to play multimedia files which are being streamed from portable terminals (e.g., the first and second N-screen devices) based on the N-screen feature. In an embodiment of the present disclosure, the shared N-screen device 410 is suitable to display shared home screens received from the first N-screen device 420 or the second N-screen device 430 together with shared N-screen device's 410 own screen, since the screen is greater than the first and second N-screen devices 420 and 430 in screen size and resolution.

In step S202, the first and second N-screen devices 420 and 430 each transmit a shared home screen to the shared N-screen device 410, and in step S203 the shared N-screen device 410 displays the received shared home screen.

If the sharing conditions for shared home screens are satisfied in step S201, the first and second N-screen devices 420 and 430 transmit the shared home screen to the shared N-screen device 410. The shared N-screen device 410 displays the shared home screen received from each N-screen device (e.g., each of the first and second N-screen devices 420 and 430) on shared N-screen device's 410 display.

In an embodiment of the present disclosure, a shared home screen may be transmitted or received in the form of a plurality of On Screen Display (OSD) layers.

Generally, N-screen devices such as tablet PCs, smart phones, and smart TVs may display their display information on a plurality of OSD layers. In displaying display information, the N-screen devices adjust transparency of each of the OSD layers by alpha blending.

A shared home screen may include the shared home screen's background image, and the above-described content and menus (e.g., a notification bar), and the shared home screen is assumed to be transmitted and received in the form of a plurality of OSD layers. For example, the shared home screen may be transmitted and received in the form of three OSD layers: an OSD layer for displaying the background image, an OSD layer for displaying the content, and an OSD layer for displaying the menus.

In an embodiment of the present disclosure, if some applications are included in content (e.g., if a widget displaying real-time information is included in content), the N-screen device may transmit the shared home screen together with an installation file for the content (e.g., an Application Package (APK) file of the widget). Therefore, upon receiving the shared home screen composed of OSD layers and the installation file for an application, the shared N-screen device may display the shared home screen and store the received installation file in the shared N-screen device's memory.

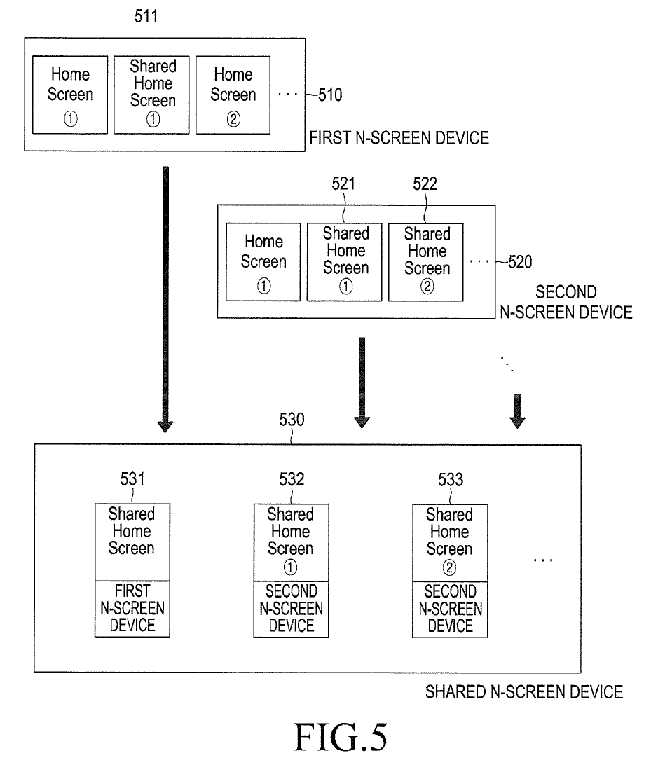

Steps S202 and S203 will be described in detail with reference to FIG. 5. If a home screen 511 among home screens 510 of a first N-screen device is a shared home screen of the first N-screen device, and home screens 521 and 522 among home screens 520 of a second N-screen device are shared home screens of the second N-screen device, the first and second N-screen devices transmit their own shared home screens to a shared N-screen device.

The shared N-screen device displays a home screen 530 including the shared home screens 531 to 533 received from the first and second N-screen devices. The shared home screen 531 corresponds to the shared home screen 511 received from the first N-screen device, and the shared home screens 532 and 533 correspond to the shared home screens 521 and 522 received from the second N-screen device, respectively.

As described in steps S202 and S203 with reference to FIG. 5, a preset N-screen device (e.g., a shared N-screen device) receives only shared home screens from other N-screen devices (e.g., the first and second N-screen devices), as shown by reference numeral 530 in FIG. 5. However, it will be understood by those skilled in the art that various changes may be made in the receiving operation.

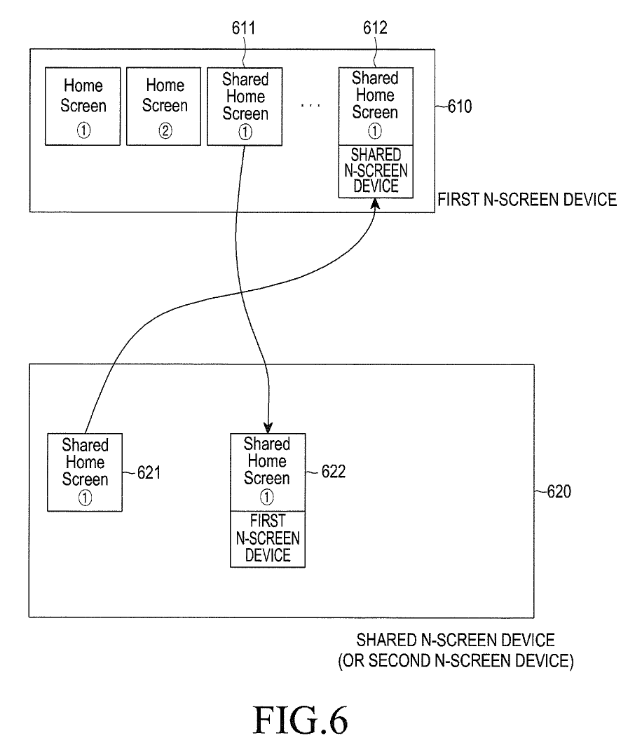

For example, as illustrated in FIG. 6, N-screen devices may exchange shared home screens with one another. As shown by reference numerals 610 and 620 in FIG. 6, the first N-screen device receives a shared home screen 621 from a shared N-screen device (or the second N-screen device) and displays the shared home screen 621 as a shared home screen 612, and the shared N-screen device (or the second N-screen device) receives a shared home screen 611 from the first N-screen device and displays the shared home screen 611 as a shared home screen 622, thereby exchanging shared home screens with each another.

In steps S204 to S207, upon detecting a request for running of content of the displayed shared home screen, the shared N-screen device requests transmitting of data corresponding to the requested content of the first and second N-screen devices. In response, the first and second N-screen devices transmit the data corresponding to the requested content, and the shared N-screen device displays the data received from the first and second N-screen devices.

A user of the shared N-screen device may enjoy content being displayed on shared home screens of each of N-screen devices (e.g., the first and second N-screen devices). The shared N-screen device may receive information corresponding to the content requested by the user, from a related N-screen device, and display it, allowing the user to enjoy the content.

It will be assumed that the shared N-screen device displays the home screen 330 shown in FIG. 3A, as a shared home screen of the first N-screen device.

If a user of the shared N-screen device requests running of an application 3 (App3) by touching an icon 330a of content, the shared N-screen device requests the first N-screen device to run the application 3 and transmit display data of the running application 3. In response, the first N-screen device runs the application 3 and transmits the associated display data to the shared N-screen device in the form of, for example, a plurality of OSD layers, and the shared N-screen device displays the received display data.

If a user of the shared N-screen device requests streaming of a multimedia file Mov1 by touching an icon 330c of content, the N screen-device requests streaming data of the multimedia file Mov1 from the first N-screen device, and plays the multimedia file being streamed from the first N-screen device.

As is well known in the art, users of an arbitrary N-screen device (e.g., the shared N-screen device) and another N-screen device (e.g., the first N-screen device) may freely enjoy the content 330a and 330c, using the N-screen function or N-screen service, so the detailed description thereof may be omitted.

In the description of steps S201 to S203, if sharing conditions for shared home screens are satisfied, each of the first and second N-screen devices with a smaller display screen transmits the shared home screen to the shared N-screen device with a larger display screen, and then the shared N-screen device displays the shared home screen received from each of the first and second N-screen devices. However, if the sharing conditions for shared home screens are not satisfied, the shared N-screen device may stop displaying the shared home screen(s) being displayed.

For example, in FIG. 4, if the second N-screen device 430, among the first and second N-screen devices 420 and 430 located within the radius R, moves out of the radius R, the shared N-screen device 410 may stop displaying the shared home screen of the second N-screen device 430, which was being displayed thereon. The shared home screen of the second N-screen device 430 is a shared home screen received from the second N-screen device 430.

As is apparent from the foregoing description, embodiments of the present disclosure may improve the usability of the N-screen service.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for sharing a home screen, the method comprising:
determining, by an N-screen device supporting an N-screen service, whether a sharing condition for a shared home screen is satisfied; and
in response to determining that the sharing condition is satisfied, transmitting, by the N-screen device, the shared home screen set to be shared in the N-screen device to another N-screen device supporting the N-screen service for display of the transmitted shared home screen at the other N-screen device.

2. The method of claim 1, wherein the shared home screen includes content arranged on a home screen and the content includes one or more icons or widgets.

3. The method of claim 2 further comprising transmitting, by the N-screen device, setting information for access rights to content of the transmitted shared home screen.

4. The method of claim 2 further comprising transmitting, by the N-screen device, an installation file for the content.

5. The method of claim 1, wherein determining comprises determining whether the N-screen device and the other N-screen device are located in a same region having a predetermined radius.

6. The method of claim 1, wherein the other N-screen device has a screen size and resolution that is larger than that of the N-screen device.

7. The method of claim 1 further comprising:
in response to detecting a request for consuming arbitrary content among the content of the received shared home content, transmitting, by the other N-screen device, request for transmitting data corresponding to the requested content, to the N-screen device.

8. The method of claim 7, further comprising:
transmitting, by the N-screen device, the data corresponding to the requested content to the other N-screen device; and
displaying, by the other N-screen device, the data corresponding to the requested content.

9. The method of claim 5, further comprising stopping, by the other N-screen device, displaying the shared home screen being received and displayed if the N-screen device and the other N-screen device are not located in the same region having the predetermined radius.

10. The method of claim 1 further comprising:
determining, by the other N-screen device, whether the sharing condition for the shared home screen is satisfied; and
in response to determining that the sharing condition for a shared home screen is satisfied, transmitting, by the other N-screen device, a shared home screen set to the N-screen device to be shared in the other N-screen device.

11. An apparatus for sharing a home screen, the apparatus comprising:
a controller for an N-screen device supporting an N-screen service, the controller configured to determine whether a sharing condition for a shared home screen is satisfied; and
a communication module configured to, in response to a determination that the sharing condition is satisfied, transmit the shared home screen set to be shared in the N-screen device to another N-screen device supporting the N-screen service for display of the transmitted shared home screen at the other N-screen device.

12. The apparatus of claim 11, wherein the shared home screen includes content arranged on a home screen and the content includes one or more icons or widgets.

13. The apparatus of claim 12, wherein the communication module is configured to transmit setting information for access rights to content of the transmitted shared home screen.

14. The apparatus of claim 12, wherein the communication module is configured to transmit an installation file for the content.

15. The apparatus of claim 11, wherein to determine whether the sharing condition for the shared home screen is satisfied, the controller is further configured to determine whether the N-screen device and the other N-screen device are located in a same region having a predetermined radius.

16. A system for sharing a home screen, the system comprising:
an N-screen device supporting an N-screen service, the N-screen device configured to determine whether a sharing condition for a shared home screen is satisfied and to, in response to determine that the sharing condition is satisfied, transmit the shared home screen set to be shared in the N-screen device to another N-screen device supporting the N-screen service; and
the other N-screen device configured to receive and display the transmitted shared home screen.

17. The system of claim 16, wherein the other N-screen device is configured to, in response to detecting a request for consuming arbitrary content among the content of the received shared home content, transmit a request for transmitting data corresponding to the requested content to the N-screen device.

18. The system of claim 17, wherein:
the N-screen device is configured to transmit the data corresponding to the requested content to the other N-screen device; and
the other N-screen device is configured to display the data corresponding to the requested content.

19. The system of claim 16, wherein:
to determine whether the sharing condition for the shared home screen is satisfied, the N-screen device is configured to determine whether the N-screen device and the other N-screen device are located in a same region having a predetermined radius; and
the other N-screen device is configured to stop displaying the shared home screen being received and displayed if the N-screen device and the other N-screen device are not located in the same region having the predetermined radius.

20. The system of claim 16, wherein the other N-screen device is configured to determine whether the sharing condition for the shared home screen is satisfied and to, in response to determining that the sharing condition for a shared home screen is satisfied, transmit to the N-screen device a shared home screen set to be shared in the other N-screen device.
